(19) United States
(12) Patent Application Publication
(10) Pub. No.: US 2007/0214264 A1
(43) Pub. Date: Sep. 13, 2007

(54) DEVICE SOCIAL-CONTROL SYSTEM

(76) Inventor: Jari Koister, Stockholm (SE)

Correspondence Address: ISHIMARU & ZAHRT LLP, 333 W. EL CAMINO REAL, SUITE 330, SUNNYVALE, CA, 94087, US

(21) Appl. No.: 11/684,587

(22) Filed: Mar. 9, 2007

Related U.S. Application Data
(60) Provisional application No. 60/743,449, filed on Mar. 9, 2006.
(60) Provisional application No. 60/744,832, filed on Apr. 13, 2006.

(51) Int. Cl. G06F 15/173

(52) U.S. Cl. 709/225

(57) ABSTRACT

A device social-control system includes: providing a computer system; and connecting the computer system to a network for: facilitating set up of an access right and an access level to control a device through the network; determining the access right from another computer system and the access level from an online social network system; and facilitating control of the device based on the access right from the another computer system and the access level from the online social network system.

### CROSS-REFERENCE TO RELATED APPLICATION(S)

The present invention claims the benefit of U.S. Provisional patent application No. 60/743,449 filed Mar. 9, 2006, and U.S. Provisional patent application No. 60/744,832 filed Apr. 13, 2006.

### TECHNICAL FIELD

The present invention relates generally to network systems, and more particularly to device control systems.

### BACKGROUND ART

Remote control of devices and home control in particular have been an active area for product development since the early days of computing. Recently home control solutions have become more viable for the mass market by virtue of emerging wireless solutions, higher penetration of computers, more powerful devices to lower prices etc. Examples of remote control and home remote control systems include cameras, lights, alarms, etc.

In addition there are many different access devices to home control systems. Lighter devices, such as PDAs, mobile phones and web tablets, have emerged as viable access control systems. The Internet allows people to access their home control systems over the Internet network, although current solutions have practical problems related to firewall issues etc.

Today's solutions provide applications that allow access to users based on traditional access methods. This means there are registered users who have each been granted rights by an application administrator. In many cases, the access is managed by the security mechanisms of the underlying operating systems, such as Windows.

There are a number of providers of home control solutions. These solutions are software applications in the traditional sense. They are installed into dedicated computers in homes and devices are being connected to them.

These systems all have access control mechanisms that are based on those used in traditional software applications. There are users with different roles. Each role implied a certain set of capabilities available for the user. An administrator grants various levels of rights to the individual users. For example, a homeowner would have full access/control while a visitor would have limited access. A cleaning person or repairperson would have even more limited access.

A capability or resource is only available by logging on to a system, such as the Internet, as a user. If a capability or resource is made generally available, it is available to all users on the Internet. While it would be desirable to provide a mechanism for granting access to a dynamically changing set of users with different interrelationships, there is currently no means for accomplishing this.

On the Internet, information is generally open to the public. However, while information can be password protected, it is then closed to anyone without the password.

Peer-to-peer systems have been used for massive distribution of media and files, such as music and movies. But there have not existed solutions where peers control devices (physical or logical) to whom access is controlled.

Solutions to these problems have been long sought but prior developments have not taught or suggested any solutions and, thus, solutions to these problems have long eluded those skilled in the art.

### DISCLOSURE OF THE INVENTION

The present invention provides a device social-control system that includes: providing a computer system; and connecting the computer system to a network for: facilitating set up of an access right and an access level to control a device through the network; determining the access right from another computer system and the access level from an online social network system; and facilitating access control related to the device based on the access right from the another computer system and the access level from the online social network system.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a schematic of a network in accordance with an embodiment of the present invention;

FIG. 2 is a schematic of a device social-control system in accordance with an embodiment of the present invention;

FIG. 3 is a schematic of an online social network system in accordance with an embodiment of the present invention;

FIG. 4 is a schematic of online social network system in accordance with another embodiment of the present invention;

FIGS. 5A-B is a flow chart of a device social-control system in accordance with another embodiment of the present invention; and

FIG. 6 is a flow chart of a device social-control system in accordance with a further embodiment of the present invention.

### BEST MODE FOR CARRYING OUT THE INVENTION

The following embodiments are described in sufficient detail to enable those skilled in the art to make and use the invention, and it is to be understood that other embodiments would be evident based on the present disclosure and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known system configurations and process steps are not disclosed in detail.

Likewise, the drawings showing embodiments of devices are semi-diagrammatic and not to scale and, particularly, some of the dimensions are for clarity of presentation and are shown greatly exaggerated in the drawing FIGS.

The embodiments of the present invention combine the power of social networking, peer-to-peer systems, device control, and privacy concerns in exposing device control into a solution that creates a unique solution that enables viral spread of device control functions. A “viral spread” is defined as the beneficial virus-like growth in popularity of people, programs, and ideas possible within the Internet. Consumer needs and concerns for security and privacy can be satisfied by combining access control to peer-to-peer network based device control with the wide distribution of device control in accordance with various embodiments of the present invention.

There is a trend of emerging social networks on the Internet. Various systems and applications are available for creating networks with people of like interests, backgrounds, etc. There are networks for professional contacts such as LinkedIn™. Other more socially oriented networks such as Friendster™ and Myspace™ also exist.

The term “space” is used to denote a living space, office space, institutional space, garden, or any other space inhabited or used by people in which manageable devices can be installed. A space has devices such as lights, cameras, shutters, locks, thermostats, etc. that can be controlled and monitored.

A “function” on device is an operation of the device, such as the operations of turning the device on or off, monitoring or turning a camera, changing the volume of a microphone, etc. Access, means both access in the normal sense and in the control sense to a device that can be controlled at an individual function level.

A “contact book” is a list of other entities that an original user has compiled that have some type of relationship to the original user; e.g., relative, friend, business acquaintance, business, organization, casual contact, etc. The contact book can be an electronic address book in a computer, personal digital assistant, or on the Internet, without limitation.

A “transitive closure” is a group of entities that includes every contact in every contact book of every user until there are no more users in any contact book. Thus, a “transitive right” is a right that can be potentially be forwarded to a transitive closure.

An “online social network system” is defined as an originator user's transitive closure. It will be a network of users where some connection exists in the relationship. The users have accepted to have a formal and visible link within the context of the online social network system. It is up to a user to accept another user as part of their contact book so each user in the online social network system has at least one other user who trusts the user enough to include the user in the online social network system.

The embodiments of the present invention have some of the following aspects that are different from what has been done before in that they allow:

1) a user to set up access rights for other users in the online social network system, and thereby publish functions and resources while still exposing them just within a trusted network.

2) a user in an online social network system to control and monitor a space according to the rights that have been granted them; e.g., the user can be part of a neighborhood watch and can monitor a friend's business, the user's parents' light switch, or the user's friend's burglar alarm.

3) a user to allow access to functions on devices based on an access level or a relationship level, where relationship is annotated for each user.

4) a user in an online social network system to control and monitor a space based on access level within a specific range of control; e.g., controlling surveillance camera to turn only certain amounts to view certain rooms of an office.

5) users to forward access rights (that have been declared as transitive) to other users in the online social network system; e.g., surveillance cameras watching pets or scenery.

6) access rights are enforced for devices placed at edges in a peer-to-peer network.

The embodiments of the present invention allow multiple, socially, or family related users with defined levels of access to monitor a plurality of homes that are their own or other user's homes, without exposing the homes and devices to the general public. Rather, it protects the privacy of the homeowners, while at the same time enabling a sharing of functions within an online social network system to allow unprecedented collaboration in space control and also viral distribution and marketing of space control functions.

In the embodiments of the present invention, if a user is somehow acquainted, and thus included in the online social network system by any other user in the online social network system, the user can be granted certain rights. These rights may also be propagated through the online social network system. This means that, if a user A gives a user B a transitive right R, user B can choose to forward that right to a user C who is not known to user A. This gives a possibility of viral spread of information and functions without opening the rights up to the general public. Rather the rights are kept within the boundaries of a network of acquaintances and acquaintances of acquaintances.

As used herein, a “device” is defined as a system that can be remotely operated or controlled. For purposes of the present invention, the term “control” refers to being able to move, view, sense, or otherwise operate a device fully or individual functions that the device is capable of performing.

This will allow users to share experiences within online social network systems (shared cameras for example), help each other monitor family members and friends who might be old or ill, control multiple homes and living spaces, monitor cameras, perform detection duties for each others homes, etc.

This is made practical by using the online social network system as the controlling mechanism for access rights in an innovative way. For example, it enables precise and controlled access right distribution in a general network of devices.

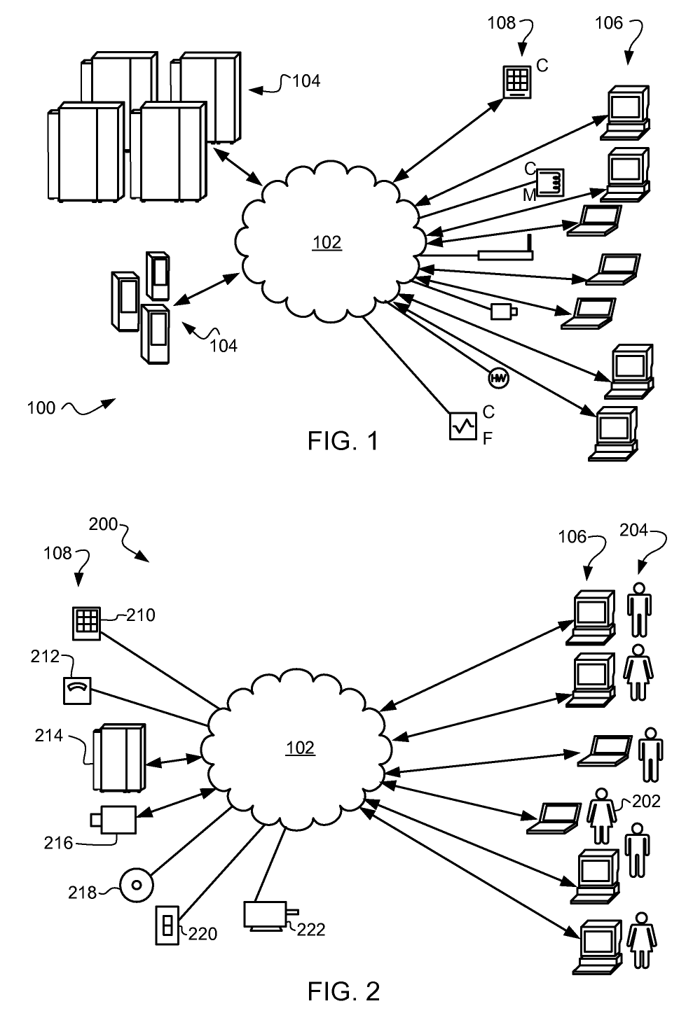

Referring now to FIG. 1, therein is shown a schematic of a network 100 in accordance with an embodiment of the present invention. The network 100 includes a network system, such as the Internet 102, which includes computer or server systems 104 providing the backbone of the network 100. The Internet 102 selectively interconnects personal computer systems 106 to control devices 108. The devices 108 can be accessed over the Internet 102 or by applications/ software in networks of computer systems that can be accessed over the Internet 102.

Referring now to FIG. 2, therein is shown a schematic of a device social-control system 200 in accordance with an embodiment of the present invention. The device social-control system 200 is a subset of the network 100 of FIG. 1, which uses the Internet 102 and the personal computer systems 106 to connect an originator user 202 to a set of users 204 with whom the original user 202 has a relationship and to the devices 108.

The relationship can be manifested in that the original user 202 and the set of users 204 have each other's email addresses, instant messaging IDs, or that all the users are registered in the device social-control system 200 and have exchanged their device social-control system identities, or any other formal or semi-formal relationship that can be captured in the device social-control system 200.

The devices 108 are exemplified by systems such as an alarm system 210, a space control system 212, a computer system 214, a camera system 216, a sensor system 218, a lighting system 220, or a motor system 222. The devices 108 have a variety of functions that user can control via the Internet 102, such as detecting warnings, controlling operations directly, controlling operations indirectly, viewing, sensing signals, activating or deactivating systems, etc.

The alarm system 210 can include a burglar alarm, temperature alarm, flooding alarm, etc.

The space control system 212 can include systems for controlling an environment through a thermostat, heating, air conditioning, ventilation, etc.

The computer system 214 contains applications or software for further running other controllable devices in a home, business, or other organization, which have the same functions as those that are directly controllable over the Internet 102.

The camera system 216 can include camcorders, digital cameras, surveillance cameras, etc. Also included in this general category would be video recorders, televisions, sound systems, projectors, etc.

The sensor system 218 can include leakage alarms, smoke detectors, radiation detectors, motion sensors, etc.

The lighting system 220 can include internal and/or external lights, decorative or seasonal lighting, intruder lighting, etc.

The motor systems 222 can include electrical or pneumatic motors for shutters, curtains, pumps, etc.

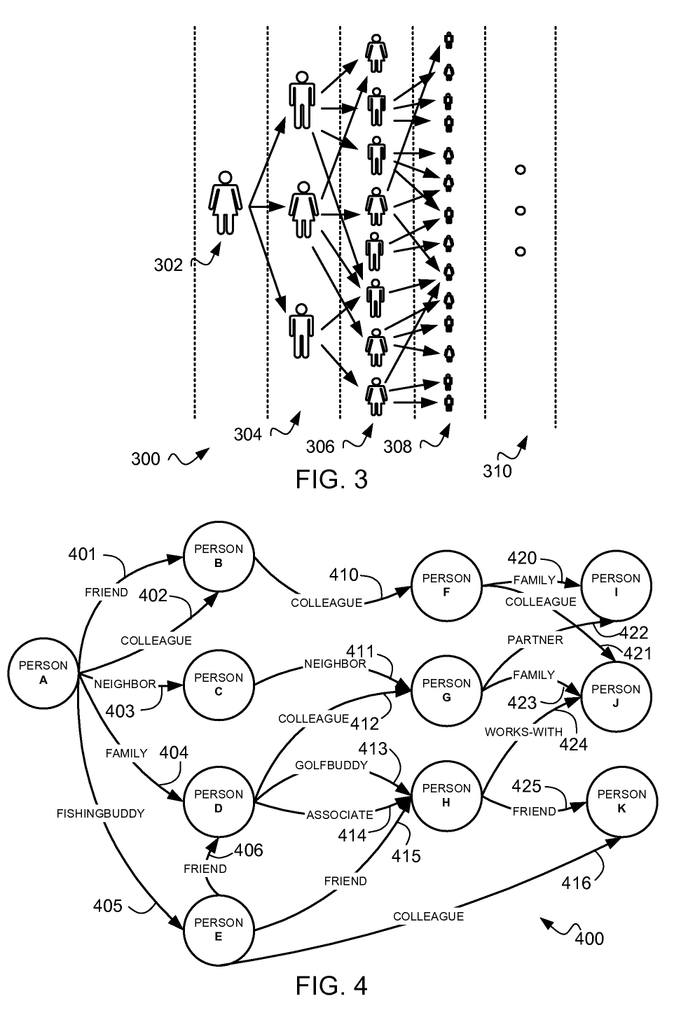

Referring now to FIG. 3, therein is shown schematic of a online social network system 300 in accordance with an embodiment of the present invention. The online social network system 300 is used by the device social-control system 200 of FIG. 2 to determine access by the users 204 to the devices 108 either completely or by function. The programming for coordinating the online social network system 300 and the device social-control system 200 can reside on the computer or server systems 104, the personal computer systems 106, or the computer system 214.

In the online social network system 300, the originator user 202 of FIG. 2 is considered to be a 1st degree user. It will be understood that human figures are shown for clarity but that each of the users is a person who has a personal computer that is connected by the arrows through a network, such as the Internet 102, to form the online social network system 300. Those who are in direct contact with the originator user 302 have a 2nd degree of relationship 304 with the originator user 302. Those who are in contact with the originator user 302 through a user having a 2d degree of relationship 304 have a 3d degree of relationship 306. Those who are in contact with the originator user 302 through the 2nd degree of relationship 304 and the 3rd degree of relationship 306 have a 4th degree of relationship 308. Similarly, those who are in contact with the originator user 302 through various other degrees of relationship extend to an nth degree of relationship 310.

For the online social network system 300, the function for gaining access to the devices 108 of FIG. 1 is determined by the degree of relationship, and a defined access right associated with the grantee or the relationship or both.

Any function can be used for allowing the originating user 302 in the online social network system 300 to grant or deny access to the devices 108 of FIG. 1 based on granted rights that are required for access.

Referring now to FIG. 4, therein is shown a schematic of a online social network system 400 in accordance with another embodiment of the present invention. The online social network system 400 is used with the device social-control system 200 of FIG. 2 to determine access by the users 204 to the devices 108 of FIG. 1 by the originator user 202 of FIG. 2 setting the level of access by the relationship of the user. The programming for coordinating the online social network system 400 and the device social-control system 200 can reside on the computer or server systems 104, the personal computer systems 106, or the computer system 214.

Each of the personal computer systems 106 contains an electronic address or contact book, which contains a portion of the set of the users 204 by name with one or more associated relationship tags or computerized annotations. Each of the set of users 204 can add to, delete, or change the associated relationship tags or annotations. In turn, each of the set of users 204 has a contact book, which contains a further portion of the set of users 204 by name with one or more associated relationship tags or annotations. In FIG. 4, each arc represents a relationship tag that connects one user to another in the contact book. It will be understood that each circle represents a person and computer system combination that is connected by the arcs and relationship tags or annotations through a network, such as the Internet 102, to form the online social network system 400.

For example, for persons A through K, there are a number of different relationship tags or annotations. For the person A and second degree related persons B through E, there are: a friend tag 401 and a colleague tag 402 to the person B; a neighbor tag to the person C; a family tag 404 to the person D; and a fishingbuddy tag 405 to the person E.

For persons in the second degree relationship, there is a friend tag 406 from the person E to the person D. For the person B and a third degree related person F, there is a colleague tag 410. For the person C and a third degree related person G, there is a neighbor tag 410. For the person D and third degree related persons G and H, there are a colleague tag 412, and a golfbuddy tag 413 and an associate tag 414. For the person E and a third degree related person H, there is a friend tag 415. Further, for the person E and a fourth degree related person K, there is a colleague tag 416.

For persons in the third degree relationship, from the person F, there are a family tag 420 to the person I and a colleague tag 421 to the person J. For the person G, there are a partner tag 422 to the person I and a family tag 423 to the person J. For the person H, there are a works-with tag 424 to the person J and a friend tag 425 to the person K.

Access rights to the devices 108 of FIG. 1 can be granted in a number of ways:

1) Absolute rights for a specific user or tag in the online social network system 400; e.g., from the person A only to the person D, who is family, or only to family.

2) Transitive rights to a user in the online social network system 400. This means that the originating user, such as person A, can define a right to be granted to a specific assigned user, such as the person B, who can grant the same access right, or a more restrictive access right, to another user, such as the persons F and I, in the specific assigned user's online social network system.

For example, a family installs a camera viewing a flashing Christmas tree. Since an installed surveillance camera is a very natural part of a home control system, through the device social-control system 200 of FIG. 2, it is accessible to the originating user, the person A, at work or elsewhere. The originating user, the person A, can always view the flashing tree. The camera can also available to the user's friends, the persons B and E, by permitting the originating user's online social network system 400 (or a subset of it) the right to access the camera. Now, all the permitted users, the persons A, B, and E, can enjoy the flashing tree. If the originating user, the person A, makes the right transitive, the user's friends, the persons B and E, have the right to forward access to the camera to their friends, the persons F, I, E, D, G, J, H, and K, in their online social network system. However, the access will still be only to those persons in the online social network system 400. The viral effect kicks in and suddenly the Christmas tree is famous within the user's social community.

Once the online social network system 400 and rights have been set, when a new user attempts to get access to the device 108 of FIG. 1, the method will first establish if the new user is in the online social network system 400 of the original user, such as the person A. If the new user is not, the access will be denied. The new user may request to become part of the online social network system 400 of the original user and then it will be at the discretion of the original user to decide if the new user is accepted or not.

If the user is in the online social network system 400, the method will establish if the user has been granted access to the device 108 either through absolute rights or transitive rights. If the so, the user will be granted access otherwise the access will be denied.

The online social network system 400 can also include a hierarchy of levels of access. For example, a family relationship will be higher than a friend relationship, which is higher than a colleague relationship. In such a hierarchy, if a colleague is granted access, the family and friend would also be granted access. If only a friend is granted access, then the family would also be granted access but not the colleague. The hierarchy of levels allows prioritization of access for controlling the device 108.

If the access to the device 108 is also controlled through trust, the trust of the user will be calculated. The result will be compared to the required level of trust for accessing this function. If the calculated level of trust is equal or higher than the required level of trust, access to the device 108 will be granted. Otherwise it will be denied.

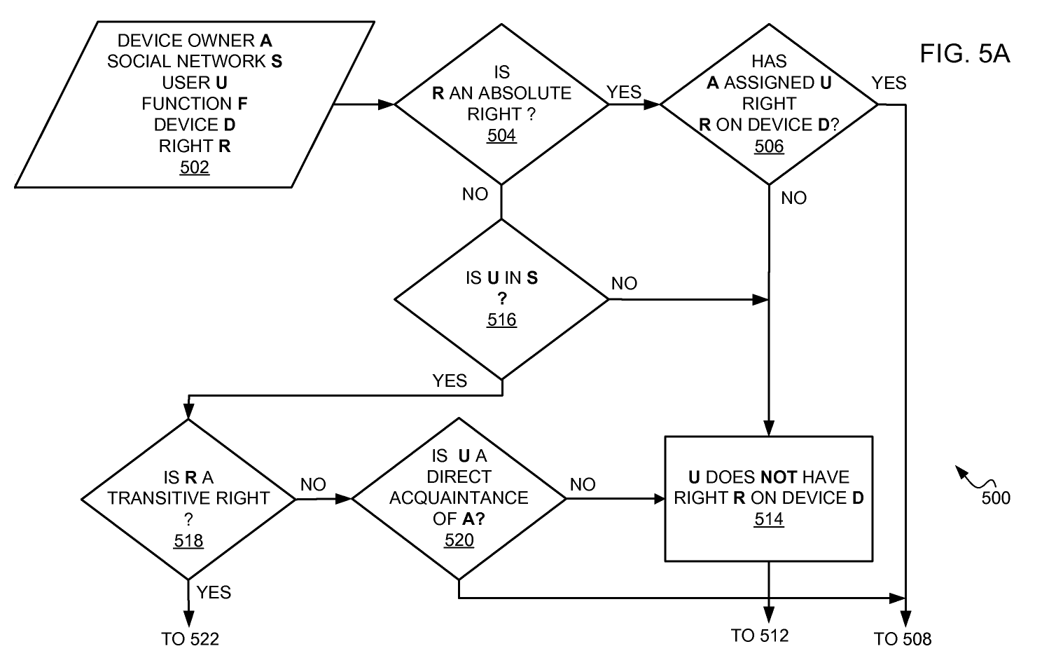

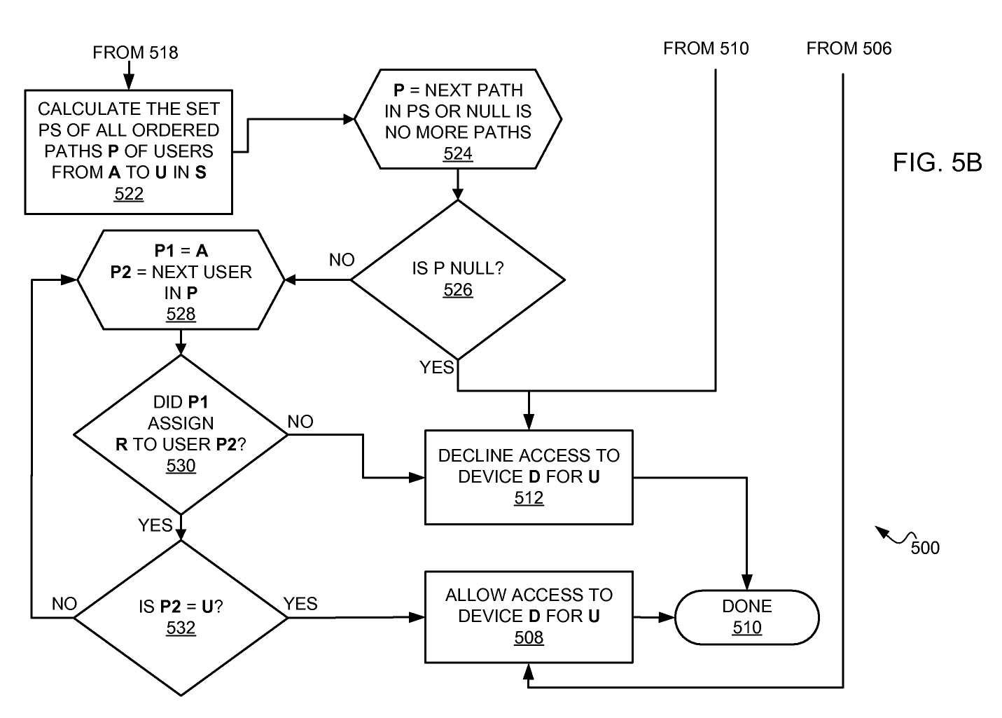

Referring now to FIGS. 5A-B, therein is shown a flow chart of the device social-control system 500 in accordance with an embodiment of the present invention. The flow chart illustrates the method of how access rights are checked with respect to the type of right assigned and the level of access set in the online social network system 400 of FIG. 4.

In a block 502, it is assumed that certain information is available in the execution environment including the device owner A, the online social network system S of a user U, the function F of a device D to which a right R is granted. The device owner A can grant absolute or transitive rights.

In a decision block 504, a determination is made whether the right R is an absolute right. If the right R is an absolute right, a decision block 506 determines if the device owner A has assigned the user U the absolute right R on the device D to access the function F. If the user U has been assigned the absolute right R in the decision block 506, the user U is allowed access to the device D in a block 508 and the method ends in a block 510. If the user U has not been assigned the absolute right R in the decision block 506, then the user U does not have a right R on device D in block 514 and the user U is not allowed access to the device D in a block 512 and the method ends in the block 510.

In the decision block 504, if the right R is not an absolute right, a determination is made in a decision block 516 to determine if the user U is in the social network S of the device owner A. If the user U is not in the online social network system S, then the user U does not have a right R on device D in the block 514 and the user U is not allowed access to the device D in the block 512 and the method ends in the block 510.

In the decision block 516, if the user U is in the online social network system S of the device owner A, a determination is made if right R is a transitive right in a decision block 518. If the right R is not a transitive right, a determination is made if the user U is a direct acquaintance (a second degree related person) of the device owner A in a decision block 520. If the user U is a direct acquaintance, the user U is allowed access to the device D in a block 508 and the method ends in a block 510. If the user U is not a direct acquaintance, then the user U does not have a right R on device D in the block 514 and the user U is not allowed access to the device D in the block 512 and the method ends in the block 510.

In the decision block 518, if it is determined that the right R is a transitive right, the set PS of all ordered paths P of users from the device owner A to the user U in the online social network system S is calculated in a block 522.

The set PS that is calculated in the block 522 uses the tags or annotations in the contact books of the other users. For example, if the device owner A is the person A of FIG. 4 and the device D is the camera 216 of FIG. 2, which is viewing a neighborhood, the person A will want to give neighbors access to the camera 216. The block 522 will find a path P using the neighbor tags or annotations to the persons C and G and also the family tag to the person J. If there are multiple tags or annotations along a relationship arc, each tag will be considers a separate arc from the perspective of transitive rights.

In a block 524, the path P is incremented by setting P equal to the next path in the set PS until there is a null.

In a decision block 526, a determination is made if the path P is null indicating that there are no more paths. If the path P is null, then the user U is not allowed access to the device D in the block 512 and the method ends in the block 510.

In the decision block 526, if the path is not null, where path P1 is the person A, path P2 is set equal to the next user in the path P in a block 528. In a decision block 530, it is determined if the path P1 was assigned the right R to users on P2. If it is determined that the right R was not assigned, the user U is not allowed access to the device D in the block 512 and the method ends in the block 510. If it is determined that the right R was assigned, the method proceeds to a decision block 532.

In the decision block 532, it is determined if path P2 is equal to the user U. If path P2 is not equal to the user U, the method returns to the block 522. If the path P2 is equal to the user U, the user U is allowed access to the device D in a block 508 and the method ends in a block 510.

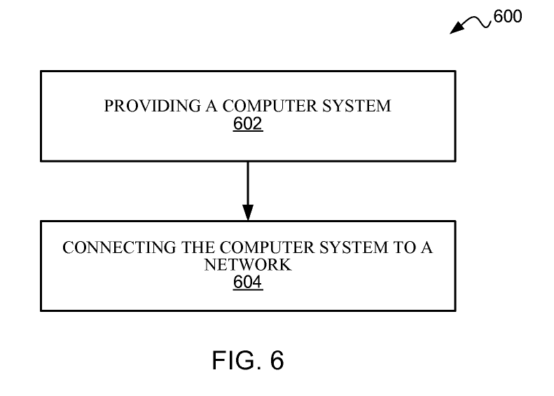

Referring now to FIG. 6, therein is shown a flow chart of a device social-control system 600 in accordance with a further embodiment of the present invention. The device social-control system 600 includes: providing a computer system in a block 602; and connecting the computer system to a network in a block 604 for: facilitating set up of an access right and an access level to control a device through the network; determining the access right from another computer system and the access level from an online social network system; and facilitating control of the device based on the access right from the another computer system and the access level from the online social network system.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A device social-control system comprising:
providing a computer system; and
connecting the computer system to a network for:
facilitating set up of an access right and an access level to control a device through the network;
determining the access right from another computer system and the access level from an online social network system; and
facilitating access control related to the device based on the access right from the another computer system and the access level from the online social network system.

2. The system as claimed in claim 1 further comprising:
setting the access right includes making the access right absolute or transitive.

3. The system as claimed in claim 1 further comprising:
setting the access level to use a trust level, a relationship level, or a combination thereof.

4. The system as claimed in claim 1 further comprising:
setting the access level to use a trust function determined by the degree of relationship on the online social network system.

5. The system as claimed in claim 1 further comprising:
setting a plurality of access levels having a hierarchy of levels of access for operation of the device.

6. The system as claimed in claim 1 further comprising:
setting the access level to use relationship tags or annotations on the online social network system.

7. The system as claimed in claim 1 wherein:
determining the access level includes using a contact book in the online social network system having a user name and a relationship tag.

8. A device social-control system comprising:
connecting a computer system to a network having a device connected thereto and an online social network system; and
controlling the device through the network based on an access right set in the network and an access level of the computer system set in the online social network system.

9. The system as claimed in claim 8 further comprising:
setting the access right includes making the access right absolute or transitive.

10. The system as claimed in claim 8 further comprising:
setting the access level to use a trust level, a relationship level, or a combination thereof.

11. The system as claimed in claim 8 further comprising:
setting the access level to use a trust function determined by the degree of relationship on the online social network system.

12. The system as claimed in claim 8 further comprising:
setting a plurality of access levels having a hierarchy of levels of access for operation of the device.

13. The system as claimed in claim 8 further comprising:
setting the access level to use relationship tags or annotations on the online social network system.

14. The system as claimed in claim 8 wherein:
determining the access level includes using a contact book in the online social network system having a user name and a relationship tag.

15. A device social-control system comprising:
providing a device controllable over a network having a computer system connected thereto;
setting an access right and an access level for controlling the device over the network by the computer system when it is part of an online social network system in the network; and
facilitating access control related to the device over the network when the computer system on the network has the access right and the access level for controlling the device in the online social network system.

16. The system as claimed in claim 15 further comprising:
setting the access right includes making the access right absolute or transitive.

17. The system as claimed in claim 15 further comprising:
setting the access level to use a trust level, a relationship level, or a combination thereof.

18. The system as claimed in claim 15 further comprising:
setting the access level to use a trust function determined by a degree of relationship on the online social network system.

19. The system as claimed in claim 15 further comprising:
setting a plurality of access levels having a hierarchy of levels of access for control of the device.

20. The system as claimed in claim 15 further comprising:
setting the access level to use relationship tags or annotations on the online social network system.
